(19) United States
(12) Patent Application Publication
(10) Pub. No.: US 2018/0208819 A1
(43) Pub. Date: Jul. 26, 2018

(54) COMPOSITION FOR CAPTURE, REMOVAL AND RECOVERY OF CHEMICAL SUBSTANCES, COMPOUNDS AND MIXTURES

(71) Applicant: Stephen Wechter, Jackson, TN (US)

(72) Inventor: Stephen Wechter, Jackson, TN (US)

(21) Appl. No.: 15/933,742

(22) Filed: Mar. 23, 2018

Related U.S. Application Data
(62) Division of application No. 15/252,800, filed on Aug. 31, 2016.
(60) Provisional application No. 62/213,170, filed on Sep. 2, 2015.

(51) Int. Cl. C09K 3/32; B01J 20/28; B01J 20/04; B01J 20/06; B01J 20/16; C02F 1/28; B01J 20/02; B01J 20/26; C02F 101/20; C02F 101/32

(52) U.S. Cl. CPC C09K 3/32; B01J 20/28016; B01J 20/046; B01J 20/06; B01J 20/16; C02F 2101/32; B01J 20/02; B01J 20/262; C02F 1/285; C02F 1/281; C02F 2101/20; C02F 1/288

(57) ABSTRACT

A composition for capturing, removing, and in some cases recovering a pollutant or raw material wherein the composition includes a polymeric material, one or more metal or nonmetal materials in granular form, and preferably a small amount of a salt material.

### CROSS-REFERENCE(S) TO RELATED APPLICATION(S)

This application is a divisional patent application claiming priority to pending U.S. Nonprovisional patent application Ser. No. 15/252,800 to Stephen R. Wechter entitled “COMPOSITION FOR CAPTURE, REMOVAL AND RECOVERY OF CHEMICAL SUBSTANCES, COMPOUNDS AND MIXTURES” filed on Aug. 31, 2016, which claims priority to U.S. Provisional Patent Application Ser. No. 62/213,170 to Stephen R. Wechter entitled “Earth Crust Chamber Component Recovery Technology” filed on Sep. 2, 2015, the contents of which are incorporated herein by reference in their respective entireties.

### FIELD

This disclosure relates to the field of chemical pollution mitigation and removal technology. More particularly, this disclosure relates to a composition for capture and removal of pollutants and other chemical substances, compounds, and mixtures.

### BACKGROUND

Environmental remediation technologies have been in use for hundreds of years. Only until the past few hundred years in the modern industrial age, however, has man been forced to deal with environmental pollution in the form of hydrocarbons and heavy metals. A first task of such environmental remediation technologies often is to try to stabilize the pollutant. In some cases, stabilization is the best solution and the pollutant remains in nature in a stabilized form. However, when possible, it is preferable to remove pollutants from the environment and to place them in a special location for long term storage. In the most optimal situation, pollutants are recovered and prepared for reuse. This often requires a purification process.

In many cases, remediation technologies are expensive and, in some cases, the remediation material used can also cause contamination or other undesirable effects in the surrounding environment. What is needed, therefore, is a material that can be used cheaply and in relatively small amounts to remediate a pollution zone.

### SUMMARY

The above and other needs are met by a composition for capturing and removing pollutants and raw materials in the form of chemical substances, compounds and mixtures. The composition may be further used to recover the pollutant or raw material in a pure form so that the pollutant or raw material can be made useful when used in a different context than the environment in which it was found.

In a preferred embodiment, the composition includes a polymeric material, one or more metal or nonmetal materials in granular form, and a small amount of salt. In some cases, silicon dioxide is also included in small to trace amounts. The composition described herein can be used to bind with hydrocarbons (e.g., crude oil, refined oil or gasoline) so that such materials can be removed from an environment such as, for example, a marine environment or a fresh water source. The composition can also be used to capture and remove heavy metals in different environments. In preferred embodiments, the composition captures a pollutant at a high ratio of 1 part composition to many parts pollutant. The applicant discovered critical components of the composition described herein that exhibit a very high capture value of up to 1:100 captures ratios by mass. These critical components were found to work within critical ranges depending on the combination of components used. The metals found to work within the critical ranges described herein include iron, copper, selenium, tin oxide, nickel and aluminum. The nonmetals materials found to work within the critical ranges described herein include silicon dioxide, phosphate compounds or mixtures and sulfur substances, compounds or mixtures. The polymeric materials in polymer and copolymer forms found to work within the critical ranges described herein include high density polyethylene, polypropylene homopolymer and/or copolymer, nylon 6, and nylon 6,6. Polystyrene was also tested but was not as efficient as the other polymers mentioned. Algal blooms on marine surfaces have been and can be captured using the invention. Once recovered, they can be dissociated from the capture components by other methods, one example of which is the use of EDTA in a stainless steel container.

More specific embodiments of the composition are disclosed including, for example, a chemical composition in the form of granules useful for capturing a pollutant, the composition comprising from about 60 wt. % to about 90 wt. % of a polymeric material and from about 10 wt. % to about 35 wt. % of a metal material.

In one embodiment, the composition further includes from about 0.1 wt. % to about 1 wt. % of a salt material. In another embodiment, the composition further includes from about 0.01 wt. % to about 0.05 wt. % of silicon dioxide.

In yet another embodiment, the polymeric material comprises a material selected from the group consisting of high density polyethylene polymer, polypropylene polymer, high density polyethylene copolymer, polypropylene copolymer, nylon 6, nylon 6,6 and combinations thereof.

In one embodiment, the metal material comprises a material selected from the group consisting of iron, copper, selenium, aluminum, nickel, tin oxide, and combinations thereof. In another embodiment, the composition further includes from about 74 wt. % to about 83 wt. % of the polymeric material and from about 17 wt. % to about 26 wt. % of the metal material, wherein the metal material essentially consists of copper.

In yet another embodiment, the composition further includes from about 79 wt. % to about 83 wt. % of the polymeric material and from about 17 wt. % to about 21 wt. % of the metal material, wherein the metal material consists essentially of iron.

In one embodiment, the composition further includes from about 76 wt. % to about 79 wt. % of the polymeric material and from about 21 wt. % to about 24 wt. % of the metal material, wherein the metal material is selected from the group consisting of selenium, nickel and combinations thereof.

In another embodiment, the composition further includes from about 77 wt. % to about 81 wt. % of the polymeric material and from about 19 wt. % to about 23 wt. % of the metal material, wherein the metal material is selected from the group consisting of aluminum, tin oxide and combinations thereof.

In yet another embodiment, the composition further includes from about 70 wt. % to about 75 wt. % of the polymeric material and from about 25 wt. % to about 30 wt. % of the metal material, wherein the polymeric material is selected from the group consisting of nylon 6, nylon 6,6 and combinations thereof.

In a second aspect, a chemical composition in the form of granules useful for capturing a pollutant is provided, the composition having from about 64 wt. % to about 90 wt. % of a polymeric material and from about 10 wt. % to about 36 wt. % of a nonmetal material.

In one embodiment, the composition further includes from about 0.1 wt. % to about 1 wt. % of a salt material.

In another embodiment, the polymeric material comprises a material selected from the group consisting of high density polyethylene polymer, polypropylene polymer, high density polyethylene copolymer, polypropylene copolymer, nylon 6, nylon 6,6 and combinations thereof.

In yet another embodiment, the composition further includes from about 82 wt. % to about 89 wt. % of the polymeric material and from about 21 wt. % to about 28 wt. % of the nonmetal material, wherein the nonmetal material consists essentially of a mixture comprising from about 85 wt. % to about 95 wt. % of sulfur.

In one embodiment, the composition further includes from about 80 wt. % to about 83 wt. % of the polymeric material and from about 17 wt. % to about 20 wt. % of the nonmetal material, wherein the nonmetal material consists essentially of a mixture comprising from about 15 wt. % to about 20 wt. % of phosphate.

In another embodiment, the composition further includes from about 76 wt. % to about 80 wt. % of the polymeric material and from about 20 wt. % to about 24 wt. % of the nonmetal material, wherein the nonmetal material consists essentially of substantially equal amounts of a first mixture comprising from about 15 wt. % to about 20 wt. % of phosphate and a second mixture comprising from about 85 wt. % to about 95 wt. % of sulfur.

In a third aspect, a chemical composition in the form of granules useful for capturing a pollutant is provided, the composition having from about 70 wt. % to about 84 wt. % of a polymeric material and from about 16 wt. % to about 30 wt. % of fly ash comprising silicon dioxide, aluminum oxide and iron oxide.

In one embodiment, the composition further includes from about 0.1 wt. % to about 1 wt. % of a salt material.

A method of preparing the composition as described herein is also disclosed. Various components of the composition are weighed or otherwise measured to determine the mass of each component. The components are then placed in a mixer, are heated and mixed together at a temperature preferably ranging from about 250° F. to about 500° F. for a period of from about ten minutes to about 30 minutes. The mixing and heating results in a “cake” mixture which is allowed to cool to room temperature. The cake is then ground up to granules and can be stored for later use by means of a hand grinder (e.g., a DeWalt 4.5 inch angle grinder) using replaceable flapper disk pads of 40-120 Z grit size. Another method for preparing the composition for larger scale commercial production is to pre-blend the components and then process them on a twin screw extruder using an underwater pelletizer to produce 0.125 inch size pellets which are further ground (e.g., a centrifugal grinder) to a size range of 200-300 microns. This finely ground composition is then stored for use.

A method for recovering a captured pollutant is also disclosed. One method of recovering the composition-pollutant complex is the use of a virtual piston (preferably powered by either pressurized helium, argon, nitrogen or other substantially inert gas) to separate the pollutant from the composition. The composition-pollutant complex is forced by the pressurized gas through a filter. Once the pollutant (e.g., gasoline, diesel fuel or crude oil) is recovered, it can be re-used. The recovery procedure has been performed using crude oil and refined oils (10W-30 motor oil, SAE 30 motor oil, gasoline and diesel fuel).

The summary provided herein is intended to provide examples of particular disclosed embodiments and is not intended to cover all potential embodiments or combinations of embodiments. Therefore, this summary is not intended to limit the scope of the invention disclosure in any way, a function which is reserved for the appended claims.

### BRIEF DESCRIPTION OF THE DRAWINGS

Further features, aspects, and advantages of the present disclosure will become better understood by reference to the following detailed description, appended claims, and accompanying figures, wherein elements are not to scale so as to more clearly show the details, wherein like reference numbers indicate like elements throughout the several views, and wherein:

FIG. 1 shows a graph of data collected regarding capture ratios when a composition comprising a metal material (iron), a polymeric material and a salt material is used to capture crude oil;

FIG. 2 shows a graph of data collected regarding capture ratios when a composition comprising a metal material, a polymeric material and a salt material is used to capture crude oil, wherein different data is presented for different metal materials tested;

FIG. 3 shows a graph of data collected regarding capture ratios when a composition comprising a metal material, a polymeric material and a salt material is used to capture refined oil, wherein different data is presented for different metal materials tested;

FIG. 4 shows a graph of data collected regarding capture ratios when a composition comprising a nonmetal material (primarily sulfur), a polymeric material and a salt material is used to capture crude oil; and

FIG. 5 shows a graph of data collected regarding capture ratios when a composition comprising a nonmetal material including phosphate, a polymeric material and a salt material is used to capture crude oil.

The figures are provided to illustrate concepts of the invention disclosure and are not intended to embody all potential embodiments of the invention. Therefore, the figures are not intended to limit the scope of the invention disclosure in any way, a function which is reserved for the appended claims.

### DETAILED DESCRIPTION

Various terms used herein are intended to have particular meanings. Some of these terms are defined below for the purpose of clarity. The definitions given below are meant to cover all forms of the words being defined (e.g., singular, plural, present tense, past tense). If the definition of any term below diverges from the commonly understood and/or dictionary definition of such term, the definitions below control.

Fly Ash: a coal combustion product in the form of fine granules.

Granules: small particles including powders typically produced by grinding, crushing or disintegrating a solid material.

Mass Fraction: The portion of a composition measured by its mass relative to the mass of the entire composition. Mass Fraction is also referred to herein as weight percent of “wt. %”.

Metal Material: a material including and preferably consisting essentially of a metal substance, compound, alloy or mixture of metal substances, compounds or alloys.

Nonmetal Material: a composition including sulfur, phosphate or combinations thereof.

Polymeric Material: a material including and preferably consisting essentially of one or more polymers, one or more copolymers, or mixtures thereof.

Salt Material: one or more salts; preferably large sodium chloride crystals sometimes referred to as “kosher salt” wherein no iodine has been added.

This disclosure describes various example embodiments of a composition for capturing, removing, and, in some cases, recovering a pollutant or raw material. The composition includes a polymeric material, one or more metal or nonmetal materials in granular form, and a small amount of salt. In some cases, silicon dioxide is also included in small to trace amounts. The composition described herein has demonstrated an ability to physically gather together and confine (or “capture”) a mass of pollutant or raw material such as, for example, crude oil, refined oil, gasoline, heavy metals and other similar pollutants and materials. The composition has demonstrated an ability to accomplish such capturing at mass ratios of up to 1 part by mass of Applicant's composition to 100 parts by mass of a pollutant or raw material. Various figures are provided herein showing different versions of the composition. Each example embodiment includes data on the composition having different concentrations of different components, and the mass to mass capture ratio at these different concentrations is shown in the tables and graphs provided herein.

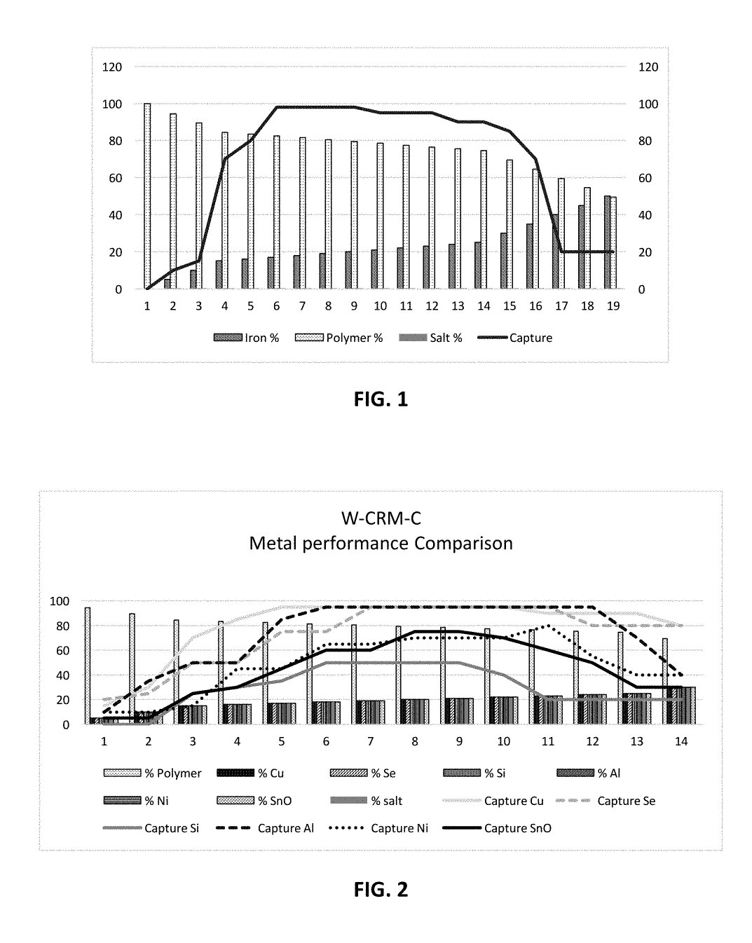

As an initial example, 5 ounces of crude oil was tested with different composition formulations. FIG. 1 shows an embodiment of the composition including a concentration of a metal material consisting essentially of iron ranging from about 15 wt. % to about 35 wt. %, more preferably from about 17 wt. % to about 25 wt. % and most preferably from about 17 wt. % to about 20 wt. %. The composition further includes a polymeric material ranging from about 65 wt. % to about 85 wt. %, more preferably from about 75 wt. % to about 83 wt. % and most preferably from about 80 wt. % to about 83 wt. %. The polymeric material may include polyethylene (preferably high density polyethylene), polypropylene or a combination thereof. The composition also preferably includes about 0.1 wt. % to about 1 wt. % and more preferably about 0.5 wt. % of a salt material. As in shown in FIG. 1, a high capture rate was demonstrated for crude oil using the composition. The data for FIG. 1 is shown below in Table 1.

TABLE 1

| Iron % | Polymer % | Salt % | Capture |
|---|---|---|---|
| 0 | 100 | 0 | 0 |
| 5 | 94.5 | 0.5 | 10 |
| 10 | 89.5 | 0.5 | 15 |
| 15 | 84.5 | 0.5 | 70 |
| 16 | 83.5 | 0.5 | 80 |
| 17 | 82.5 | 0.5 | 98 |
| 18 | 81.5 | 0.5 | 98 |
| 19 | 80.5 | 0.5 | 98 |
| 20 | 79.5 | 0.5 | 98 |
| 21 | 78.5 | 0.5 | 95 |
| 22 | 77.5 | 0.5 | 95 |
| 23 | 76.5 | 0.5 | 95 |
| 24 | 75.5 | 0.5 | 90 |
| 25 | 74.5 | 0.5 | 90 |
| 30 | 69.5 | 0.5 | 85 |
| 35 | 64.5 | 0.5 | 70 |
| 40 | 59.5 | 0.5 | 20 |
| 45 | 54.5 | 0.5 | 20 |
| 50 | 49.5 | 0.5 | 20 |

Other metal materials were also tested including copper, selenium, aluminum, nickel, and tin oxide. Silicon was also tested. The various versions of the composition and associated capture ratios are provided below in Table 2 and are shown in FIG. 2.

TABLE 2

| | | | | | | | | Capture | Capture | Capture | Capture | Capture | Capture |
|---|---|---|---|---|---|---|---|---|---|---|---|---|---|
| % Polymer | % Cu | % Se | % Si | % Al | % Ni | % SnO | % salt | Cu | Se | Si | Al | Ni | SnO |
| 94.5 | 5 | 5 | 5 | 5 | 5 | 5 | 0.5 | 15 | 20 | 0 | 10 | 10 | 5 |
| 89.5 | 10 | 10 | 10 | 10 | 10 | 10 | 0.5 | 30 | 25 | 0 | 35 | 10 | 5 |
| 84.5 | 15 | 15 | 15 | 15 | 15 | 15 | 0.5 | 70 | 50 | 25 | 50 | 15 | 25 |
| 83.5 | 16 | 16 | 16 | 16 | 16 | 16 | 0.5 | 85 | 50 | 30 | 50 | 45 | 30 |
| 82.5 | 17 | 17 | 17 | 17 | 17 | 17 | 0.5 | 95 | 75 | 35 | 85 | 45 | 45 |
| 81.5 | 18 | 18 | 18 | 18 | 18 | 18 | 0.5 | 95 | 75 | 50 | 95 | 65 | 60 |
| 80.5 | 19 | 19 | 19 | 19 | 19 | 19 | 0.5 | 95 | 95 | 50 | 95 | 65 | 60 |
| 79.5 | 20 | 20 | 20 | 20 | 20 | 20 | 0.5 | 95 | 95 | 50 | 95 | 70 | 75 |
| 78.5 | 21 | 21 | 21 | 21 | 21 | 21 | 0.5 | 95 | 95 | 50 | 95 | 70 | 75 |
| 77.5 | 22 | 22 | 22 | 22 | 22 | 22 | 0.5 | 95 | 95 | 40 | 95 | 70 | 70 |
| 76.5 | 23 | 23 | 23 | 23 | 23 | 23 | 0.5 | 90 | 95 | 20 | 95 | 80 | 60 |
| 75.5 | 24 | 24 | 24 | 24 | 24 | 24 | 0.5 | 90 | 80 | 20 | 95 | 55 | 50 |
| 74.5 | 25 | 25 | 25 | 25 | 25 | 25 | 0.5 | 90 | 80 | 20 | 70 | 40 | 30 |
| 69.5 | 30 | 30 | 30 | 30 | 30 | 30 | 0.5 | 80 | 80 | 20 | 40 | 40 | 30 |

For the embodiment of the composition including copper, the metal material is present in an amount ranging from about 15 wt. % to about 30 wt. %, more preferably from about 16 wt. % to about 27 wt. % and most preferably from about 17 wt. % to about 22 wt. %. The polymeric material is present in an amount ranging from about 70 wt. % to about 85 wt. %, more preferably from about 73 wt. % to about 84 wt. % and most preferably from about 78 wt. % to about 83 wt. %. A salt material is preferably present in an amount of from about 0.1 wt. % to about 1 wt. % and more preferably about 0.5 wt. %.

For the embodiment of the composition primarily including selenium, the metal material is present in an amount ranging from about 17 wt. % to about 30 wt. % and most preferably from about 19 wt. % to about 23 wt. %. The polymeric material is present in an amount ranging from about 70 wt. % to about 83 wt. % and most preferably from about 77 wt. % to about 81 wt. %. A salt material is preferably present in an amount of from about 0.1 wt. % to about 1 wt. % and more preferably about 0.5 wt. %.

For the embodiment of the composition primarily including aluminum, the metal material is present in an amount ranging from about 15 wt. % to about 27 wt. %, more preferably from about 17 wt. % to about 25 wt. % and most preferably from about 18 wt. % to about 24 wt. %. The polymeric material is present in an amount ranging from about 73 wt. % to about 85 wt. %, more preferably from about 75 wt. % to about 83 wt. % and most preferably from about 76 wt. % to about 82 wt. %. A salt material is preferably present in an amount of from about 0.1 wt. % to about 1 wt. % and more preferably about 0.5 wt. %.

For the embodiment of the composition primarily including nickel, the metal material is present in an amount ranging from about 16 wt. % to about 30 wt. %, more preferably from about 18 wt. % to about 24 wt. % and most preferably about 23 wt. %. The polymeric material is present in an amount ranging from about 70 wt. % to about 84 wt. %, more preferably from about 76 wt. % to about 82 wt. % and most preferably about 77 wt. %. A salt material is preferably present in an amount of from about 0.1 wt. % to about 1 wt. % and more preferably about 0.5 wt. %.

For the embodiment of the composition primarily including tin oxide, the metal material is present in an amount ranging from about 15 wt. % to about 30 wt. %, more preferably from about 18 wt. % to about 24 wt. % and most preferably from about 20 wt. % to about 22 wt. %. The polymeric material is present in an amount ranging from about 70 wt. % to about 85 wt. %, more preferably from about 76 wt. % to about 82 wt. % and most preferably from about 78 wt. % to about 80 wt. %. A salt material is preferably present in an amount of from about 0.1 wt. % to about 1 wt. % and more preferably about 0.5 wt. %.

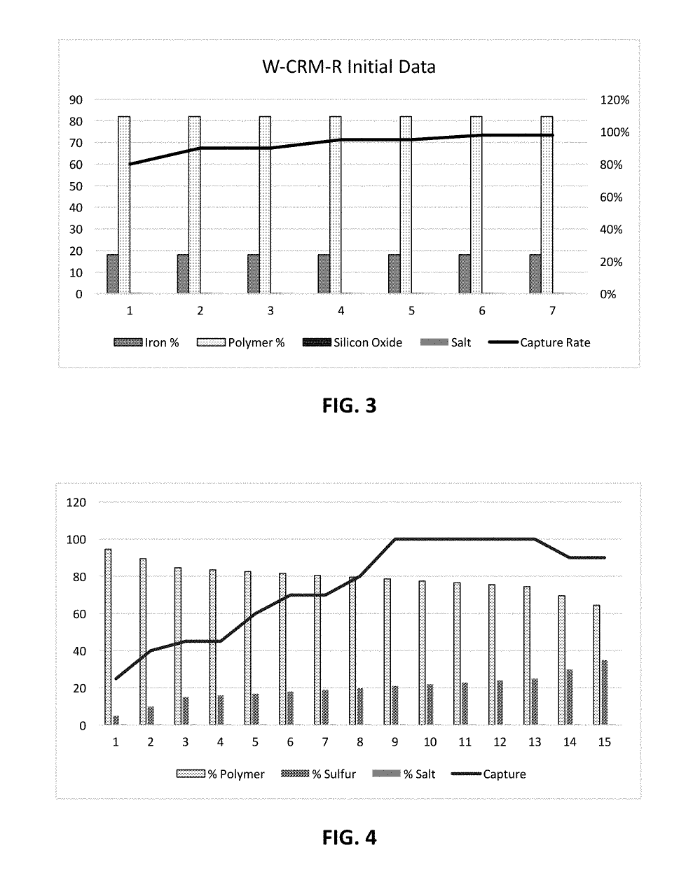

Similar tests were run with respect to refined oil, and a preferred composition was determined to be from about 16 wt. % to about 20 wt. % of a metal material consisting essentially of iron, from about 80 wt. % to about 84 wt. % of a polymeric composition, from about 0.1 wt. % to about 1 wt. % of a salt material, and a trace amount of silicon dioxide. Other metal materials were also tested with refined oil and those test results are shown in Table 3 and FIG. 3. For these tests, a minimum amount of silicon dioxide was included.

TABLE 3

| | | | | | | | | Capture | Capture | Capture | Capture | Capture | Capture | |
|---|---|---|---|---|---|---|---|---|---|---|---|---|---|---|
| % Polymer | % Cu | % Se | % Si | % Al | % Ni | % SnO | % salt | Cu | Se | Si | Al | Ni | SnO | % SiO2 |
| 94.5 | 5 | 5 | 5 | 5 | 5 | 5 | 0.5 | 10 | 30 | 0 | 15 | 10 | 5 | 0.01 |
| 89.5 | 10 | 10 | 10 | 10 | 10 | 10 | 0.5 | 20 | 60 | 0 | 40 | 10 | 5 | 0.01 |
| 84.5 | 15 | 15 | 15 | 15 | 15 | 15 | 0.5 | 75 | 70 | 15 | 50 | 15 | 20 | 0.01 |
| 83.5 | 16 | 16 | 16 | 16 | 16 | 16 | 0.5 | 80 | 70 | 15 | 50 | 30 | 20 | 0.01 |
| 82.5 | 17 | 17 | 17 | 17 | 17 | 17 | 0.5 | 90 | 70 | 20 | 65 | 30 | 30 | 0.01 |
| 81.5 | 18 | 18 | 18 | 18 | 18 | 18 | 0.5 | 90 | 80 | 20 | 80 | 45 | 35 | 0.01 |
| 80.5 | 19 | 19 | 19 | 19 | 19 | 19 | 0.5 | 90 | 85 | 30 | 90 | 50 | 40 | 0.01 |
| 79.5 | 20 | 20 | 20 | 20 | 20 | 20 | 0.5 | 90 | 90 | 35 | 90 | 50 | 40 | 0.01 |
| 78.5 | 21 | 21 | 21 | 21 | 21 | 21 | 0.5 | 90 | 95 | 60 | 90 | 60 | 40 | 0.01 |
| 77.5 | 22 | 22 | 22 | 22 | 22 | 22 | 0.5 | 90 | 100 | 60 | 90 | 60 | 40 | 0.01 |
| 76.5 | 23 | 23 | 23 | 23 | 23 | 23 | 0.5 | 90 | 100 | 60 | 85 | 60 | 35 | 0.01 |
| 75.5 | 24 | 24 | 24 | 24 | 24 | 24 | 0.5 | 90 | 90 | 30 | 80 | 50 | 35 | 0.01 |
| 74.5 | 25 | 25 | 25 | 25 | 25 | 25 | 0.5 | 90 | 90 | 30 | 60 | 30 | 20 | 0.01 |
| 69.5 | 30 | 30 | 30 | 30 | 30 | 30 | 0.5 | 80 | 90 | 30 | 60 | 30 | 20 | 0.01 |

A composition primarily including copper as the metal material are contemplated for use for capturing refined oil wherein the metal material comes in a concentration ranging from about 15 wt. % to about 30 wt. % and more preferably from about 17 wt. % to about 25 wt. %. The remaining portion of the composition would include polymeric material and salt.

A composition primarily including selenium as the metal material are contemplated for use for capturing refined oil wherein the metal material comes in a concentration ranging from about 10 wt. % to about 30 wt. %, more preferably from about 15 wt. % to about 25 wt. %, and most preferably from about 20 wt. % to about 23 wt. %. The remaining portion of the composition would include polymeric material and salt.

A composition primarily including aluminum as the metal material are contemplated for use for capturing refined oil wherein the metal material comes in a concentration ranging from about 15 wt. % to about 30 wt. %, more preferably from about 17 wt. % to about 24 wt. %, and most preferably from about 19 wt. % to about 22 wt. %. The remaining portion of the composition would include polymeric material and salt.

A composition primarily including nickel as the metal material are contemplated for use for capturing refined oil wherein the metal material comes in a concentration ranging from about 16 wt. % to about 30 wt. %, more preferably from about 18 wt. % to about 24 wt. %, and most preferably from about 21 wt. % to about 23 wt. %. The remaining portion of the composition would include polymeric material and salt.

A composition primarily including tin oxide as the metal material are contemplated for use for capturing refined oil wherein the metal material comes in a concentration ranging from about 15 wt. % to about 30 wt. %, more preferably from about 17 wt. % to about 25 wt. %, and most preferably from about 19 wt. % to about 22 wt. %. The remaining portion of the composition would include polymeric material and salt.

In some embodiments, a nonmetal material was included in lieu of a metal material. FIG. 4 and Table 4 below show an embodiment of the composition including from about 17 wt. % to about 50 wt. %, more preferably from about 20 wt. % to about 40 wt. % and most preferably from about 21 wt. % to about 25 wt. % of a nonmetal material wherein the nonmetal material consists essentially of sulfur or a mixture of from about 85 wt. % to about 95 wt. % of sulfur. A polymeric material is present in an amount ranging from about 50 wt. % to about 83 wt. %, more preferably from about 60 wt. % to about 80 wt. % and most preferably from about 75 wt. % to about 79 wt. %. A salt material is preferably present in an amount of from about 0.1 wt. % to about 1 wt. % and more preferably about 0.5 wt. %. The data in this example is based on the treatment of crude oil.

TABLE 4

| % Polymer | % Sulfur | % Salt | Capture |
|---|---|---|---|
| 94.5 | 5 | 0.5 | 25 |
| 89.5 | 10 | 0.5 | 40 |
| 84.5 | 15 | 0.5 | 45 |
| 83.5 | 16 | 0.5 | 45 |
| 82.5 | 17 | 0.5 | 60 |
| 81.5 | 18 | 0.5 | 70 |
| 80.5 | 19 | 0.5 | 70 |
| 79.5 | 20 | 0.5 | 80 |
| 78.5 | 21 | 0.5 | 100 |
| 77.5 | 22 | 0.5 | 100 |
| 76.5 | 23 | 0.5 | 100 |
| 75.5 | 24 | 0.5 | 100 |
| 74.5 | 25 | 0.5 | 100 |
| 69.5 | 30 | 0.5 | 90 |
| 64.5 | 35 | 0.5 | 90 |

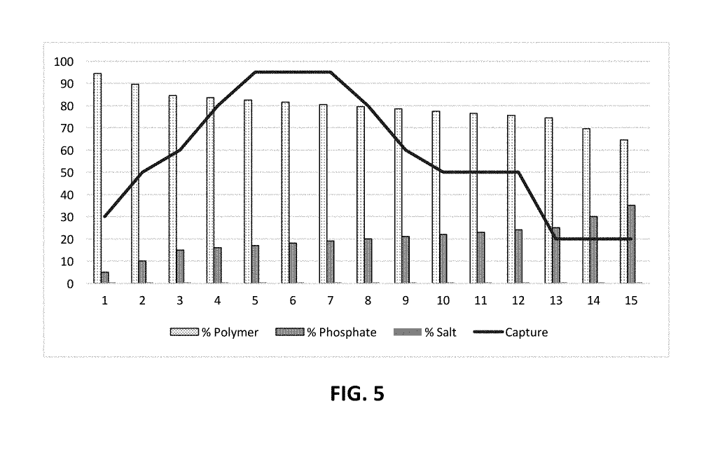

FIG. 5 and Table 5 show an embodiment of the composition including from about 10 wt. % to about 24 wt. %, more preferably from about 15 wt. % to about 21 wt. % and most preferably from about 17 wt. % to about 19 wt. % of a nonmetal material wherein the nonmetal material consists essentially of a mixture of from about 10 wt. % to about 25 wt. % of phosphate and more preferably from about 15 wt. % to about 20 wt. %. A polymeric material is present in an amount ranging from about 76 wt. % to about 90 wt. %, more preferably from about 79 wt. % to about 85 wt. % and most preferably from about 81 wt. % to about 83 wt. %. A salt material is preferably present in an amount of from about 0.1 wt. % to about 1 wt. % and more preferably about 0.5 wt. %. The data in this example is based on the treatment of crude oil.

TABLE 5

| % Polymer | % Phosphate | % Salt | Capture |
|---|---|---|---|
| 94.5 | 5 | 0.5 | 30 |
| 89.5 | 10 | 0.5 | 50 |
| 84.5 | 15 | 0.5 | 60 |
| 83.5 | 16 | 0.5 | 80 |
| 82.5 | 17 | 0.5 | 95 |
| 81.5 | 18 | 0.5 | 95 |
| 80.5 | 19 | 0.5 | 95 |
| 79.5 | 20 | 0.5 | 80 |
| 78.5 | 21 | 0.5 | 60 |
| 77.5 | 22 | 0.5 | 50 |
| 76.5 | 23 | 0.5 | 50 |
| 75.5 | 24 | 0.5 | 50 |
| 74.5 | 25 | 0.5 | 20 |
| 69.5 | 30 | 0.5 | 20 |
| 64.5 | 35 | 0.5 | 20 |

Table 6 shows an embodiment of the composition including a nonmetal material comprising substantially equal parts of a first subcomponent consisting essentially of sulfur or sulfur-containing mixture and a second subcomponent consisting essentially of a phosphate-containing mixture. The first subcomponent is preferably substantially pure sulfur or is a mixture that comprises from about 85 wt. % to about 95 wt. % sulfur. The phosphate in the second subcomponent is in a concentration of from about 10 wt. % to about 25 wt. % and more preferably from about 15 wt. % to about 20 wt. %. The nonmetal material as a whole found in the composition comes in a concentration ranging from about 16 wt. % to about 34 wt. %, more preferably from about 18 wt. % to about 26 wt. %, and most preferably from about 20 wt. % to about 22 wt. %. The composition also includes a polymeric material in a concentration ranging from about 66 wt. % to about 84 wt. %, more preferably from about 74 wt. % to about 82 wt. %, and most preferably from about 78 wt. % to about 80 wt. %. A salt material is preferably present in an amount of from about 0.1 wt. % to about 1 wt. % and more preferably about 0.5 wt. %.

TABLE 6

| % Polymer | % Sulfur | % Phosphate | % Salt | Capture |
|---|---|---|---|---|
| 89.5 | 5 | 5 | 0.5 | 40 |
| 87.5 | 6 | 6 | 0.5 | 40 |
| 83.5 | 8 | 8 | 0.5 | 50 |
| 81.5 | 9 | 9 | 0.5 | 80 |
| 79.5 | 10 | 10 | 0.5 | 95 |
| 77.5 | 11 | 11 | 0.5 | 95 |
| 75.5 | 12 | 12 | 0.5 | 95 |
| 73.5 | 13 | 13 | 0.5 | 80 |
| 71.5 | 14 | 14 | 0.5 | 60 |
| 69.5 | 15 | 15 | 0.5 | 50 |
| 67.5 | 16 | 16 | 0.5 | 50 |
| 65.5 | 17 | 17 | 0.5 | 50 |

Table 7 shows an embodiment of the composition including a nonmetal material comprising a first subcomponent consisting essentially of sulfur or sulfur-containing mixture and a second subcomponent consisting essentially of a phosphate-containing mixture. The first subcomponent is preferably substantially pure sulfur or is a mixture that comprises from about 85 wt. % to about 95 wt. % sulfur. The first subcomponent of the composition preferably comes in a concentration ranging from about 7 wt. % to about 21 wt. %. The phosphate in the second subcomponent is in a concentration of from about 10 wt. % to about 25 wt. % and more preferably from about 15 wt. % to about 20 wt. %. The second subcomponent of the composition preferably comes in a concentration ranging from about 3 wt. % to about 24 wt. %. The composition also includes a polymeric material in a concentration ranging from about 55 wt. % to about 90 wt. %. A salt material is preferably present in an amount of from about 0.1 wt. % to about 1 wt. % and more preferably about 0.5 wt. %. In one particularly preferred embodiment, the first subcomponent comes in a concentration ranging from about 12 wt. % to about 21 wt. % and the second subcomponent comes in a concentration ranging from about 4 wt. % to about 7 wt. %. In another preferred embodiment, the first subcomponent comes in a concentration ranging from about 8 wt. % to about 15 wt. % and the second subcomponent comes in a concentration ranging from about 20 wt. % to about 25 wt. %. A salt material is preferably present in an amount of from about 0.1 wt. % to about 1 wt. % and more preferably about 0.5 wt. %.

TABLE 7

| % Polymer | % Sulfur | % Phosphate | % Salt | Capture |
|---|---|---|---|---|
| 91.5 | 6 | 2 | 0.5 | 50 |
| 87.5 | 9 | 3 | 0.5 | 80 |
| 83.5 | 12 | 4 | 0.5 | 95 |
| 79.5 | 15 | 5 | 0.5 | 100 |
| 75.5 | 18 | 6 | 0.5 | 100 |
| 71.5 | 21 | 7 | 0.5 | 100 |
| 67.5 | 8 | 24 | 0.5 | 90 |
| 71.5 | 7 | 21 | 0.5 | 80 |
| 75.5 | 6 | 18 | 0.5 | 60 |
| 79.5 | 5 | 15 | 0.5 | 50 |
| 83.5 | 4 | 12 | 0.5 | 50 |
| 91.5 | 2 | 6 | 0.5 | 50 |

It is sometimes difficult or otherwise expensive to obtain highly pure metals in granular form or otherwise. Fly ash, however, is a readily available byproduct of coal combustion containing silicon dioxide, aluminum oxide, iron oxide and, in some case, calcium oxide. Fly ash was tested as a component in the disclosed composition and was tested in a concentration raging from about 5 wt. % to about 30 wt. %. The test data is shown below in Table 8. The more fly ash that was added to the composition, the greater the capture ratio of the composition. In one related embodiment, a composition is disclosed including from about 15 wt. % to about 50 wt. % fly ash. The composition further includes from about 50 wt. % to about 85 wt. % of a polymeric material. A salt material is preferably present in an amount of from about 0.1 wt. % to about 1 wt. % and more preferably about 0.5 wt. %.

TABLE 8

| % Polymer | % Fly Ash | % Salt | Capture |
|---|---|---|---|
| 94.5 | 5 | 0.5 | 30 |
| 89.5 | 10 | 0.5 | 50 |
| 88.5 | 11 | 0.5 | 50 |
| 87.5 | 12 | 0.5 | 50 |
| 86.5 | 13 | 0.5 | 70 |
| 85.5 | 14 | 0.5 | 90 |
| 84.5 | 15 | 0.5 | 95 |
| 83.5 | 16 | 0.5 | 100 |
| 82.5 | 17 | 0.5 | 100 |
| 81.5 | 18 | 0.5 | 100 |
| 80.5 | 19 | 0.5 | 100 |
| 79.5 | 20 | 0.5 | 100 |
| 78.5 | 21 | 0.5 | 100 |
| 77.5 | 22 | 0.5 | 100 |
| 74.5 | 25 | 0.5 | 100 |
| 69.5 | 30 | 0.5 | 100 |

Other materials can be substituted for substantially pure metal materials such as, for example, iron carbonate, iron silicate slag, and hematite just to name a few examples. The capture performance of these ores using crude oil as the pollutant was not as promising as using pure metals, but the tests demonstrated that such ores can still be used with some success. Iron carbonate performed the best out of these three ores. Capture data for these ores is shown below in Table 9. Steel shavings were also substituted in as the metal material in an experiment for capturing refined oil, the results of which are shown in Table 10.

TABLE 9

| | % | | | | | | |
|---|---|---|---|---|---|---|---|
| | Iron | % | | % | | Iron | Hema- |
| % | Silicate | Hema- | | Poly- | FeCO₃ | Silicate | tite |
| FeCO₃ | Slag | tite | Salt | mer | Capture | Capture | Capture |
| 5 | 5 | 5 | 0.05 | 94.5 | 5 | 0 | 0 |
| 10 | 10 | 10 | 0.05 | 89.5 | 5 | 0 | 0 |
| 15 | 15 | 15 | 0.05 | 84.5 | 40 | 10 | 5 |
| 16 | 16 | 16 | 0.05 | 83.5 | 40 | 15 | 5 |
| 17 | 17 | 17 | 0.05 | 82.5 | 45 | 15 | 5 |
| 18 | 18 | 18 | 0.05 | 81.5 | 45 | 20 | 8 |
| 19 | 19 | 19 | 0.05 | 80.5 | 50 | 20 | 8 |
| 20 | 20 | 20 | 0.05 | 79.5 | 45 | 20 | 10 |
| 21 | 21 | 21 | 0.05 | 78.5 | 45 | 25 | 15 |
| 22 | 22 | 22 | 0.05 | 77.5 | 45 | 20 | 15 |
| 23 | 23 | 23 | 0.05 | 76.5 | 45 | 20 | 15 |
| 24 | 24 | 24 | 0.05 | 75.5 | 40 | 20 | 15 |
| 25 | 25 | 25 | 0.05 | 74.5 | 40 | 20 | 15 |
| 30 | 30 | 30 | 0.05 | 73.5 | 40 | 20 | 20 |

TABLE 10

| % Polymer | % Steel Shavings | % Salt | % SiO₂ | Capture |
|---|---|---|---|---|
| 99.5 | 0 | 0.4 | 0.1 | <1 |
| 94.5 | 5 | 0.4 | 0.1 | 15 |
| 89.5 | 10 | 0.4 | 0.1 | 20 |
| 84.5 | 15 | 0.4 | 0.1 | 65 |
| 83.5 | 16 | 0.4 | 0.1 | 70 |
| 82.5 | 17 | 0.4 | 0.1 | 70 |
| 81.5 | 18 | 0.4 | 0.1 | 85 |
| 80.5 | 19 | 0.4 | 0.1 | 90 |
| 79.5 | 20 | 0.4 | 0.1 | 90 |
| 78.5 | 21 | 0.4 | 0.1 | 90 |
| 77.5 | 22 | 0.4 | 0.1 | 90 |
| 76.5 | 23 | 0.4 | 0.1 | 95 |
| 75.5 | 24 | 0.4 | 0.1 | 90 |
| 74.5 | 25 | 0.4 | 0.1 | 90 |
| 69.5 | 30 | 0.4 | 0.1 | 85 |

Another embodiment of the composition described herein was developed specifically for use in capturing and removing heavy metals. In this embodiment, the metal selected for testing was iron but other metal materials are contemplated for use with respect to this embodiment. In this embodiment, the metal material comes in a concentration ranging from about 10 wt. % to about 50 wt. %, more preferably from about 15 wt. % to about 35 wt. % and most preferably from about 25 wt. % to about 30 wt. %. The polymeric material selected for this embodiment is nylon 6 and/or nylon 6,6, but other nylon formulations are contemplated. The polymeric material comes in a concentration ranging from about 50 wt. % to about 90 wt. %, more preferably from about 65 wt. % to about 85 wt. % and most preferably from about 70 wt. % to about 75 wt. %. A salt material is preferably present in an amount of from about 0.1 wt. % to about 1 wt. % and more preferably about 0.5 wt. %. Silicon dioxide is also preferably present in an amount of at least from about 0.01 wt. % to about 0.1 wt. %. Some of the data associated with this embodiment is shown below in Table 11. This embodiment is particularly suited for use underwater in environments such as, for example, river beds.

TABLE 11

| Nylon % | Iron % | salt % | Silicon Oxide % | Capture |
|---|---|---|---|---|
| 50 | 50 | 0.5 | 0.01 | 40 |
| 55 | 45 | 0.5 | 0.01 | 40 |
| 60 | 40 | 0.5 | 0.01 | 50 |
| 65 | 35 | 0.5 | 0.01 | 60 |
| 70 | 30 | 0.5 | 0.01 | 70 |
| 75 | 25 | 0.5 | 0.01 | 70 |

A method of preparing the composition described herein is disclosed. As a first step, various components of the composition are weighed or otherwise measured to determine the mass of each component. The components are then placed in a mixer, are heated and mixed together at a temperature preferably ranging from about 250° F. to about 500° F. for a period of from about ten minutes to about 30 minutes. The mixing and heating results in a “cake” mixture which is allowed to cool to room temperature. The cake is then ground up to granules and can be stored for later use. The grinding is preferably accomplished using a hand grinder (e.g., a DeWalt brand 4.5 inch angle grinder) using replaceable flapper disk pads of 36Z to 120Z grit size. Another method for preparing the composition for larger scale commercial production is to pre-blend the components and then process the component mixture on an extruder using a pelletizer to produce pellets (e.g., 0.125 inch interior diameter size) which are further ground using, for example, a centrifugal grinder to a size range of from about 200 to about 300 microns. This finely ground composition is then stored for use.

A method for recovering a captured pollutant is also disclosed. One method of recovering the composition-pollutant complex is the use of a virtual piston (preferably powered by either pressurized helium, argon, nitrogen or other substantially inert gas) to separate the pollutant from the composition. The composition-pollutant complex is forced by the pressurized gas through a filter. Once the pollutant (e.g., gasoline, diesel fuel or crude oil) is recovered, it can be re-used. To accomplish the recovery process, a 304 stainless steel Schedule 40 cylinder was fabricated with a support plate in the middle upon which a series of nitrocellulose 0.45 micron Millipore filters were placed. To access and replace the filters, a quick release clamp was used to insure the seal between the upper and lower stainless steel chambers. The composition-pollutant complex was either pumped into the upper chamber using a Cole-Palmer peristaltic pump (the interior diameter of the stainless steel connection hose being 1 inch), or manually poured into the top chamber through a stainless steel funnel. Once sufficient pollutant-composition complex was in the top chamber, it was sealed by means of an attached stainless steel 1 inch inline ball valve. The residual water in the chamber was evacuated using a low pressure vacuum pump which was attached to a welded 0.125 inch interior diameter stainless steel pipe nipple just beneath the filter assembly. After evacuation and collection of the residual water through the lower chamber, to which another 1 inch interior diameter stainless steel inline ball valve was attached and served as the outflow port, the top input inline ball valve was closed and the substantially inert gas was pumped into the upper chamber at pressures ranging from 10 psi to about 60 psi to force the pollutant off the composition and down through the lower chamber output valve opening for recovery. Once pollutant recovery was complete, the composition was removed for cleaning, drying and further use. This recovery procedure has been successfully performed using crude oil and refined oils (10W-30 motor oil, SAE 30 motor oil, gasoline and diesel fuel).

The various embodiments described herein are used to capture and remove various pollutants, mixtures and substances including oil, heavy metals, and algae. Embodiments of the invention are particularly well suited for capturing and removing such materials from marine environments. Capture and removal can also be accomplished in fresh water including river beds or on land. Heavy metals can be removed from materials such as, for example, coal tar and fly ash. Embodiments are useful for agricultural capture of pollutants where a metallic component may be undesirable for use on farmable (arable) land, such as pollutant leaks that may spill on to farmable lands. Embodiments of the composition can be prepared in solid form, powder form, a fluidized form, and can be applied to a fixed structure such as, for example, a filter or screen. Based on experimentation, it appears that once the composition has been used to capture and remove a pollutant such as crude oil, and after the crude oil is separated from the composition, the composition actually performs slightly better. Without being bound by any particular theory, it is believed that some residual pollutant in the composition causes the apparent improvement in performance. Also, depending on the components used, embodiments of the invention can be configured to float, hover, or sink in water or other fluid.

The previously described embodiments of the present disclosure have many advantages, including the mass to mass ratio at which the composition described herein can capture and remove pollutants. This feature is helpful because it takes very little of the composition to capture and remove a relatively large mass of pollutant. A major advantage of the composition described herein is the selective removal, and potential commercial use, of heavy metal complexes which are either left in place for long periods of time, or placed in landfills, with the consequence of gravity seepage into natural water tables or watersheds where toxic contamination may occur. Another advantage of this embodiment is the collection, purification and re-use of components within these heavy metal complexes. For example, Portland cement uses fly ash residues as a minor component, so less than about 25% could be used up to about 50%.

The foregoing description of preferred embodiments of the present disclosure has been presented for purposes of illustration and description. The described preferred embodiments are not intended to be exhaustive or to limit the scope of the disclosure to the precise form(s) disclosed. Obvious modifications or variations are possible in light of the above teachings. The embodiments are chosen and described in an effort to provide the best illustrations of the principles of the disclosure and its practical application, and to thereby enable one of ordinary skill in the art to utilize the concepts revealed in the disclosure in various embodiments and with various modifications as are suited to the particular use contemplated. All such modifications and variations are within the scope of the disclosure as determined by the appended claims when interpreted in accordance with the breadth to which they are fairly, legally, and equitably entitled.

What is claimed is:

1. A chemical composition in the form of granules useful for capturing a pollutant, the composition comprising from about 64 wt. % to about 90 wt. % of a polymeric material and from about 10 wt. % to about 36 wt. % of a nonmetal material.

2. The composition of claim 1 further comprising from about 0.1 wt. % to about 1 wt. % of a salt material.

3. The composition of claim 1 wherein the polymeric material comprises a material selected from the group consisting of high density polyethylene polymer, polypropylene polymer, high density polyethylene copolymer, polypropylene copolymer, nylon 6, nylon 6,6 and combinations thereof.

4. The composition of claim 1 further comprising from about 82 wt. % to about 89 wt. % of the polymeric material and from about 21 wt. % to about 28 wt. % of the nonmetal material, wherein the nonmetal material consists essentially of a mixture comprising from about 85 wt. % to about 95 wt. % of sulfur.

5. The composition of claim 1 further comprising from about 80 wt. % to about 83 wt. % of the polymeric material and from about 17 wt. % to about 20 wt. % of the nonmetal material, wherein the nonmetal material consists essentially of a mixture comprising from about 15 wt. % to about 20 wt. % of phosphate.

6. The composition of claim 1 further comprising from about 76 wt. % to about 80 wt. % of the polymeric material and from about 20 wt. % to about 24 wt. % of the nonmetal material, wherein the nonmetal material consists essentially of substantially equal amounts of a first mixture comprising from about 15 wt. % to about 20 wt. % of phosphate and a second mixture comprising from about 85 wt. % to about 95 wt. % of sulfur.
